(19) United States
(12) Patent Application Publication
(10) Pub. No.: US 2012/0012760 A1
(43) Pub. Date: Jan. 19, 2012

(54) Laser irradiation apparatus

(76) Inventors: Won-Kyu Lee, Yongin-City (KR); Seong-Hyun Jin, Yongin-city (KR); Jae-Hwan Oh, Yongin-city (KR); Young-Jin Chang, Yongin-city (KR); Jae-Beom Choi, Yongin-city (KR)

(21) Appl. No.: 13/067,617

(22) Filed: Jun. 15, 2011

(30) Foreign Application Priority Data
Jul. 16, 2010 (KR) 10-2010-0069153

(51) Int. Cl. G21K 5/10

(52) U.S. Cl. 250/492.22

(57) ABSTRACT

A laser irradiation apparatus provides a laser beam along a scan direction to a semiconductor layer including a plurality of pixel areas. The laser irradiation apparatus includes at least one laser mask including a plurality of slit groups respectively facing portions of the plurality of pixel areas and a laser generator generating the laser beam that pass through the plurality of slit groups of the at least one laser mask.

### BACKGROUND

1. Field

Embodiments relate generally to a laser irradiation apparatus. More particularly, the described technology relates generally to a laser irradiation apparatus that crystallizes a semiconductor layer by using laser beams.

2. Description of the Related Art

Most flat panel display devices, such as an organic light emitting diode (OLED) display, a liquid crystal display (LCD), and the like, are manufactured through several types of thin film processes. Particularly, a low temperature polycrystalline silicon thin film transistor (LTPS TFT) having excellent carrier mobility may be used for many applications, e.g., a high-speed operation circuit, a CMOS circuit, and so forth, so is commonly employed.

The LTPS TFT includes a polycrystalline silicon layer formed by crystallizing an amorphous silicon layer. Methods for crystallizing the amorphous layer include a solid phase crystallization method, an excimer laser crystallization method, and a crystallization method using a metal catalyst.

Among the various crystallization methods, the excimer laser crystallization method has been widely used because it enables low temperature process so that a thermal effect on a substrate is relatively low and enables to make a polycrystalline silicon layer having an relatively excellent carrier mobility, e.g., in excess of 100 cm²/Vs. However the excimer crystallization method requires scanning each semiconductor with slit-patterned laser beams. This results in the excimer crystallization method having a much lower throughput than other crystallization methods.

The above information disclosed in this Background section is only for enhancement of understanding of the background of the described technology and therefore it may contain information that does not form the prior art that is already known in this country to a person of ordinary skill in the art.

### SUMMARY

Embodiments are therefore directed to a laser irradiation apparatus, which substantially overcomes one or more of the problems due to the limitations and disadvantages of the related art.

It is therefore a feature of an embodiment to provide a laser irradiation apparatus providing improved throughput.

At least one of the above and other features and advantages may be realized by providing a laser irradiation apparatus that irradiates laser beams to a semiconductor layer including a plurality of pixel areas along a scan direction. In addition, the laser irradiation apparatus includes at least one laser mask including a plurality of slit groups respectively facing parts of the plurality of pixel areas and a laser generator generating the laser beams that pass through the plurality of slit groups of at least one laser mask.

The plurality of pixel areas of the semiconductor layer may be divided into a crystallization area and a non-crystallization area, and the crystallization and the non-crystallization area may be alternately arranged along the scan direction.

The crystallization areas may be located in the same portions in the respective pixel areas.

The plurality of slit groups may correspond to the crystallization area of the semiconductor layer.

A gap between the plurality of slit groups may be the same and may be proportional to the scan direction distance of the non-crystallization area of the semiconductor layer.

One of the slit groups may include a plurality of slits of which long axes are parallel with the scan direction.

Crystallization protrusions may be formed in parallel with the scan direction in the crystallization area of the semiconductor layer.

One of the slit groups may include a plurality of first slits and a plurality of slits that are arranged in a direction that is perpendicular to the scan direction and equivalent to each other in size. The plurality of first slits and the plurality of second slits may be arranged to be deviated from each other by ½ of the slit width.

Sides of the plurality of first and second slits may be gradually narrowed at both ends in an oblique shape.

One of the slit groups may include a plurality of slits of which long axes are perpendicular to the scan direction.

Crystallization protrusions may be arranged in a direction that crosses the scan direction in the crystallization area of the semiconductor layer.

In the laser irradiation apparatus, the laser generator may include a first laser generator oscillating a first laser beam and a second laser generator oscillating a second laser beam.

The first laser generator and the second laser generator may turn on/off oscillation of the first and second laser beams with a predetermined cycle.

The predetermined cycle may be inversely proportional to the scan speed of the first and second laser beams and directly proportional to the length of the pixel area in the scan direction.

One cycle of the predetermined cycle may correspond to a distance of the first and second laser beams irradiated toward the scan direction by the pixel area.

A time that at least one of the first and second laser beams may be turned on corresponds to a distance between the crystallization areas along the scan direction in the semiconductor layer. A time that at least one of the first and second laser beams may be turned off corresponds to a distance of the non-crystallization areas along the scan direction in the semiconductor layer.

The first laser beam and the second laser beam may be sequentially oscillated with a time gap.

When there is more than one laser mask, the first and second laser beams may be respectively divided and directed onto each laser mask.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic diagram of a display device according to a first exemplary embodiment.

FIG. 2 illustrates a top plan view of a slit group of a laser mask of FIG. 1.

FIG. 3 illustrates a top plan view of pixel areas crystallized by a laser irradiation apparatus of FIG. 1.

FIG. 4 and FIG. 5 illustrate graphs, respectively, of an oscillation cycle and a waveform of a laser beam oscillated from a laser generator of FIG. 1.

FIG. 6 illustrates a schematic diagram of a display device according to a second exemplary embodiment.

FIG. 7 illustrates a top plan view of a slit group of a laser mask of FIG. 6.

FIG. 8 illustrates a top plan view of pixel areas crystallized by a laser irradiation apparatus of FIG. 6.

### DETAILED DESCRIPTION

Korean Patent Application No. 10-2010-0069153, filed on Jul. 16, 2010, in the Korean Intellectual Property Office, and entitled: “Laser Irradiation Apparatus,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Constituent elements having the same structures throughout the embodiments are denoted by the same reference numerals and are described in a first exemplary embodiment. In the subsequent exemplary embodiments, only the constituent elements other than the same constituent elements are described.

Furthermore, as the size and thickness of the respective structural components shown in the drawings are arbitrarily illustrated for explanatory convenience, the present invention is not necessarily limited to the illustrated.

In the drawings, for better understanding and ease of description, the thickness of layers, films, panels, regions, etc., are exaggerated for clarity. It will be understood that when an element such as a layer, film, region, or substrate is referred to as being “on” another element, it can be directly on the other element or intervening elements may also be present.

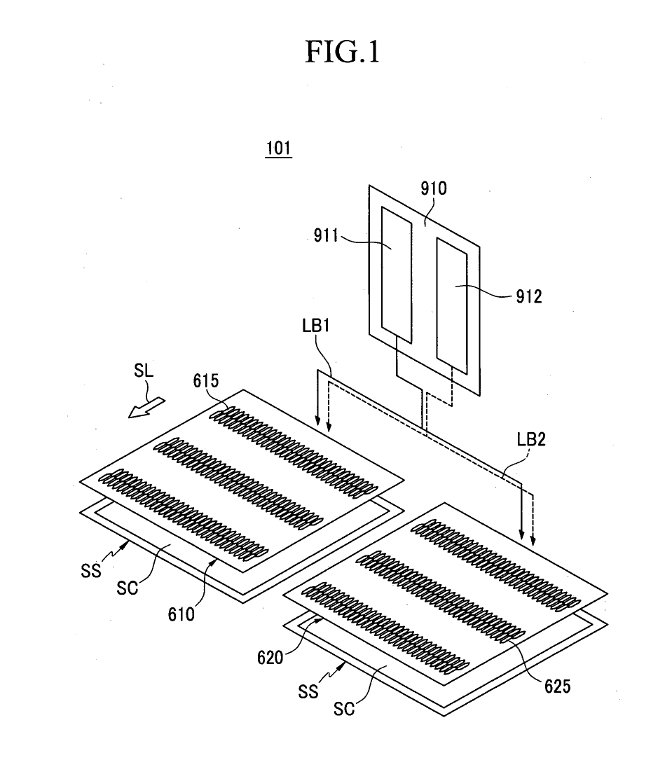

Hereinafter, a laser irradiation apparatus 101 according to a first exemplary embodiment will be described with reference to FIG. 1 to FIG. 5.

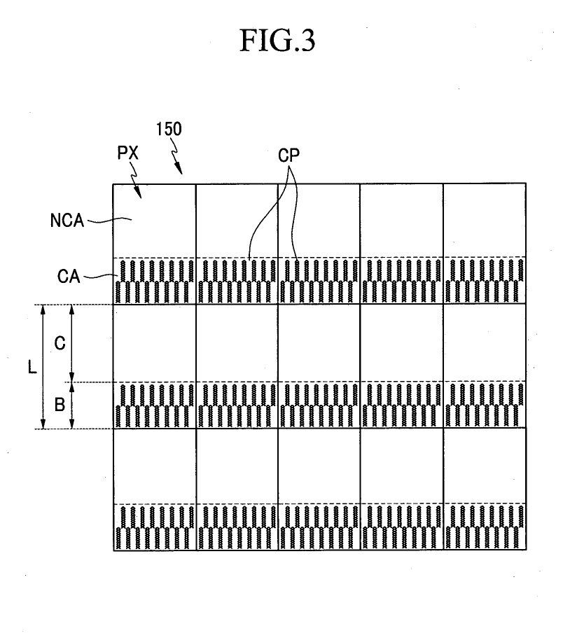

As shown in FIG. 1, the laser irradiation apparatus 101 according to the first exemplary embodiment irradiates laser beams LB1 and LB2 along a scan direction SL to a semiconductor layer SC formed on a substrate SS. The semiconductor layer SC includes a plurality of pixels PX (shown in FIG. 3). The laser beams LB1 and LB2 crystallize a part of each of the plurality of pixel areas PX (shown in FIG. 3).

The laser irradiation apparatus 101 includes a laser generator 910 and at least one of laser masks 610 and 620. In FIG. 1, two of laser masks 610 and 620 are used, but the first exemplary embodiment is not limited thereto. Thus, one or three or more laser masks may be used.

Additionally, although not shown, the laser irradiation apparatus may further include a transfer unit that transfers the substrate SS including the semiconductor layer SC and the laser masks 610 and 620 or transfers the laser generator 910, i.e., moves the laser generator relative to the semiconductor layer SC and the laser masks 610 and 620. Additionally, although not shown, the laser irradiation apparatus 101 may further include a lens unit disposed between the laser masks 610 and 620 and the semiconductor layer SC.

The laser generator 910 generates laser beams for crystallization of the semiconductor layer SC. In particular, in of the laser beams LB1 and LB2 output from the laser generator 910 are split, pass through the plurality of laser masks 610 and 620, and are then directed onto the semiconductor layer SC formed in the substrate SS.

In the first exemplary embodiment, the laser generator 910 includes a first laser generator 911 outputting the first laser beam LB1 and a second laser generator 912 outputting the second laser beam LB2. The first laser beam LB1 is split and output to both laser masks 610 and 620. The second laser beam LB2 is also split and output to both laser masks 610 and 620. A number of beams each laser beam output from the laser generator 910 is split into may equal a number of laser masks.

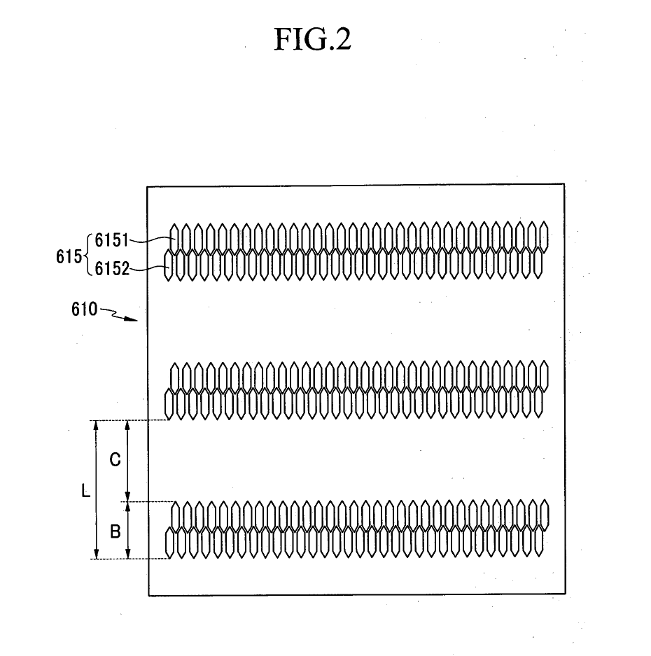

As shown in FIG. 2, the plurality of laser masks 610 and 620 respectively include a plurality of slit groups 615 and 625 respectively facing parts of the plurality of pixel areas PX (shown in FIG. 3) of the semiconductor layer SC. The laser beams LB1 and LB2 output from the laser generator 910 pass through slits 6151 and 6152 included in each slit group 615 of the laser mask 610 and move toward the semiconductor layer SC. Similarly, the laser beams LB1 and LB2 output from the laser generator 910 pass through the slit group 625 of the laser mask 620 and move toward the semiconductor layer SC.

As shown in FIG. 3, each of the plurality of pixel areas PX is divided into a crystallization area CA and a non-crystallization area NCA. The crystallization area CA is crystallized by the laser beams LB1 and LB2 incident thereon through the slit groups 615 and 625 of the laser masks 610 and 620. The non-crystallization area NCA is not crystallized because the laser beams LB1 and LB2 are blocked by the laser masks 610 and 620. That is, the plurality of slit groups 615 and 625 of the plurality of laser masks 610 and 620 correspond to the crystallization area CA of each pixel area PX.

As shown in FIG. 2, the slit groups 615 are spaced apart from each other with an equivalent gap C therebetween. In addition, the gap C between each of the plurality of slit groups 615 of FIG. 2 is proportional to a distance C of the scan direction SL of the non-crystallization area NCA of FIG. 3. Further, a total length of each slit group 615 and 625 is B and is proportional to a total length B of each crystallization area CA.

Accordingly, the crystallization area CA having the length B and the non-crystallization area NCA having the gap or length C are alternately arranged along the scan direction SL. In addition, the crystallization area CA is located at the same location in each of the plurality of pixel areas PX. That is, the locations of the crystallization areas CA and the slit groups 615 and 625 are equal to each other.

In addition, in the first exemplary embodiment, one slit group 615 includes a plurality of slits 6151 and 6152 having long axes parallel with the scan direction SL. Each slit group 615 and 625 include a plurality of first slits 6151 and a plurality of second slits 6152 that are disposed along the perpendicular direction of the scan direction SL and have a same size. In this case, the plurality of the first slits 6151 and the plurality of the second slits 6152 are arranged to be shifted from each other by ½ of the slit width. In addition, sides of the plurality of first and second slits 6151 and 6152 are gradually narrowed to form an oblique shape.

Since the sides of the slit 6151 and 6152 are oblique, when the semiconductor layer SC is crystallized through the laser masks 610 and 620 having the first and second slits 6151 and 6152, the growth direction of crystal particles is similar to that of crystal particles that grow in a portion corresponding to the center of the slits 6151 and 6152, even through the crystal grows perpendicularly with respect to the sides in a portion corresponding to the edge of the slits 6151 and 6152. Thus, crystal growth in portions corresponding edges of the slits 6151 and 6152 is influenced to be similar to crystal growth in portions corresponding to the center of the slits 6151 and 6152. Accordingly, crystal growth may be relatively uniform in the semiconductor layer SC.

In addition, as shown in FIG. 3, crystallization protrusions CP are formed along a direction parallel with the scan direction SL in the crystallization area CA crystallized by the laser masks 610 and 620 in the above-described shape.

In addition, in the first exemplary embodiment, the plurality of laser masks includes the first laser mask 610 and the second laser mask 620. However, the first exemplary embodiment is not limited thereto. Thus, the laser irradiation apparatus 101 may include one, three, or more laser masks.

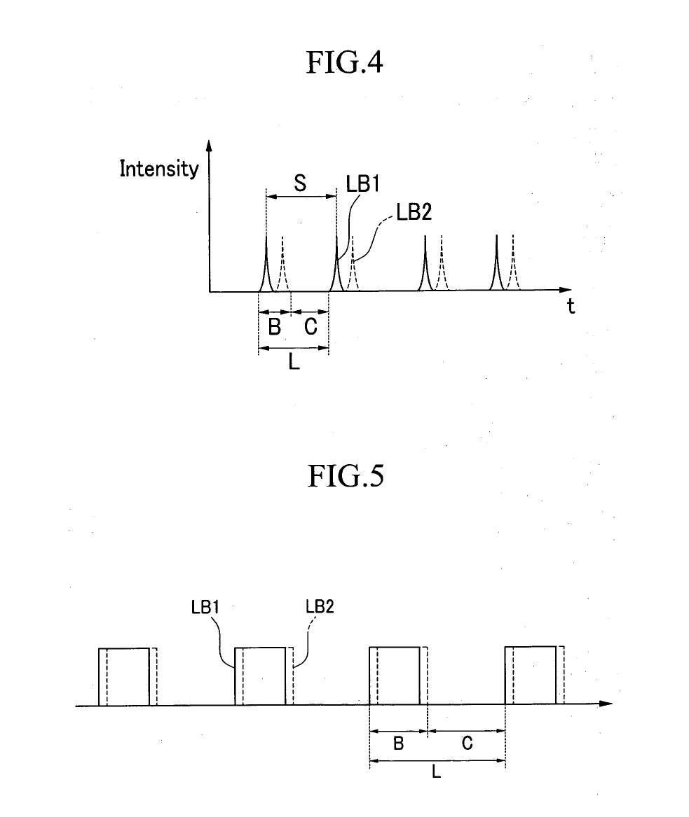

As shown in FIG. 4, the first laser generator 911 and the second laser generator 912 respectively turn on/off the first and second laser beams LB1 and LB2 with a predetermined cycle L. The predetermined cycle L may be changed according to a scan speed S of the laser beams LB1 and LB2, and depends on the length B of the crystallization area CA of the pixel area PX (shown in FIG. 3) in the scan direction SL of the laser beams LB1 and LB2.

In further detail, the predetermined cycle L is inversely proportional to the scan speed S of the first laser beam LB1 and the second laser beam LB2, and is directly proportional to the length B of each crystallization area CA of the plurality of pixel areas PX in the scan direction SL. That is, the predetermined cycle L decreases as the scan speed S increases and/or the length B of crystallization area CA of the pixel area PX in the scan direction SL decreases. Conversely, the predetermined cycle L increases as the scan speed S decreases and/or the length B of the crystallization area CA of the pixel area PX in the scan direction SL increases. As shown in FIG. 3, one cycle of the predetermined cycle L corresponds to a distance L of the first and second laser beams LB1 and LB2, irradiated along the scan direction SL for one pixel area PX.

In addition, the first laser beam LB1 and the second laser beam LB2 are directed along the same scan direction SL. However, the first exemplary embodiment is not limited thereto. Therefore, the scan direction SL of the first laser beam LB1 and the scan direction SL of the second laser beam LB2 may be different from each other.

As shown in FIG. 5, a pulse duration time of at least one of the first and second laser beams LB1 and LB2 corresponds to the distance of the crystallization area CA of the pixel areas PX in the scan direction SL. In other words, over the length B of the crystallization area CA in the scan direction SL, at least one of the first and second laser beams LB1 and LB2 is incident on the crystallization area CA. In addition, a time that the pulse of at least one of the first and second laser beams LB1 and LB2 is discontinued corresponds to the distance C of the non-crystallization area NCA of the pixel areas PX in the scan direction SL. That is, the length of one pixel area PX in the scan direction equals the sum of the length B of one crystallization area CA in the scan direction and the length C of one non-crystallization area NCA in the scan direction. In addition, one on/off period of the first and second laser beams LB1 and LB2 corresponds to a time that one pixel area PX is scanned by the first and second laser beams LB1 and LB2.

In addition, as shown in FIG. 4, the first laser beam LB1 and the second laser beam LB2 may be sequentially oscillated with a time gap in the first exemplary embodiment. In this case, time for irradiation of the laser beams LB1 and LB2 to the crystallization area CA can be stably guaranteed. That is, during one predetermined cycle L of the first and second laser beams LB1 and LB2, one pixel area PX can be stably divided into the crystallization area CA and the non-crystallization area NCA and then crystallized.

Alternatively, the crystallization area CA in one pixel area PX may be used as a semiconductor layer of a thin film transistor. In addition, an organic light emitting element and the like may be disposed in the non-crystallization area NCA. A capacitor may be formed in the crystallization area CA or may be formed in the non-crystallization area NCA.

With such a configuration, the laser irradiation apparatus 101 according to the first exemplary embodiment can effectively improve the throughput.

With the laser irradiation apparatus 101 according to the first exemplary embodiment, one pixel area PX can be partially crystallized instead of crystallizing the entire area of the pixel area PX. In addition, the semiconductor layer SC formed in each of the plurality of substrates SS may also be crystallized.

Thus, energy saved through selective crystallization can be used for simultaneous crystallization of the semiconductor layer SC formed in each of the plurality of substrates SS. That is, the throughput may be effectively improved without changing a total energy amount of the laser beams LB1 and LB2 output from the laser generator 910.

In addition, the pixel area PX may be selectively crystallized by sequentially outputting the laser beams LB1 and LB2 from the plurality of laser generators 910 and 920.

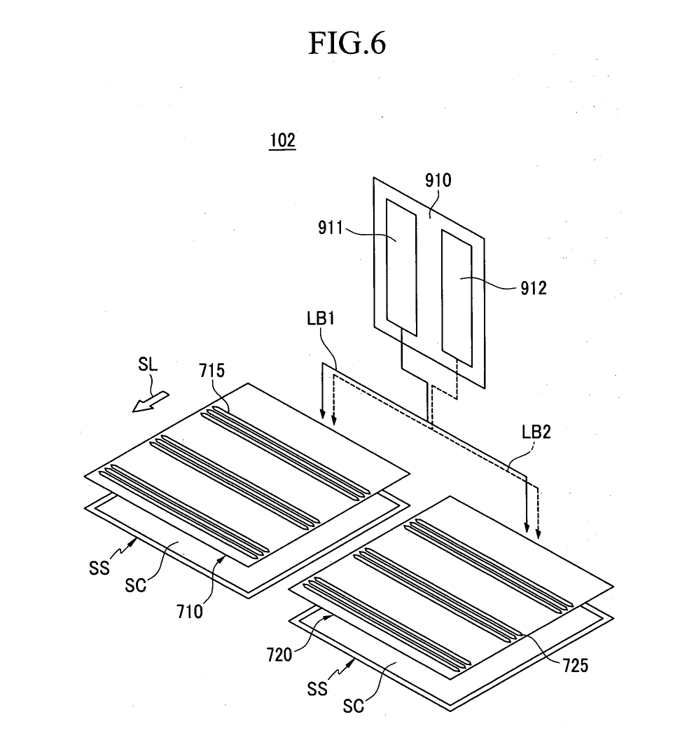

Hereinafter, a laser irradiation apparatus 102 according to a second exemplary embodiment will be described with reference to FIG. 6 to FIG. 8.

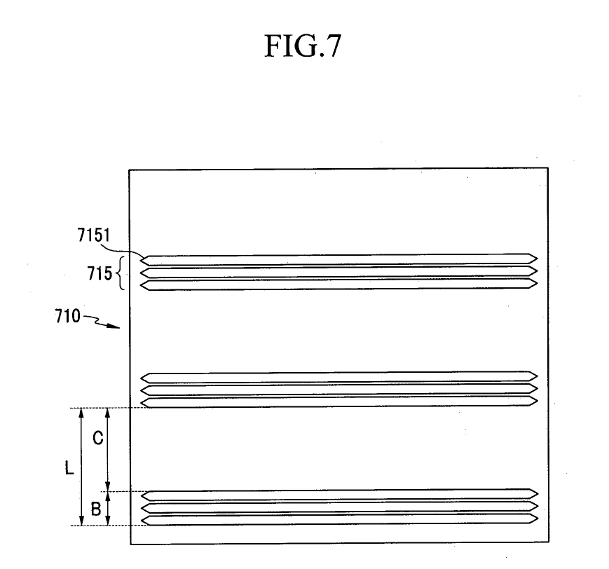

As shown in FIG. 6, in the laser irradiation apparatus 102 according to the second exemplary embodiment, a plurality of laser masks 710 and 720 include a plurality of slit groups 715 and 725, and each slit group includes a plurality of slits 7151 (shown in FIG. 7) of which long axes are perpendicular to a scan direction. That is, the plurality of slits 7151 extended in a direction that is perpendicular to a scan direction SL are arranged along the scan direction SL.

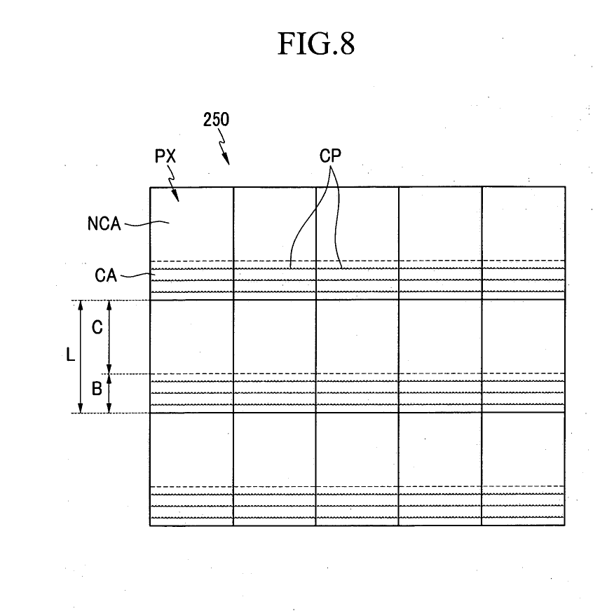

In the crystallization area CA crystallized by the laser beams LB1 and LB2 through masks 710 and 720 in the above-described shape, crystallization protrusions CA are formed along the direction that is perpendicular to the scan direction SL as shown in FIG. 8.

With such a configuration, the laser irradiation apparatus 102 according to the second exemplary embodiment can effectively improve the throughput.

In addition, the first exemplary embodiment and the second exemplary embodiment are different in the arrangement direction of the crystallization protrusions CP formed in the crystallization area CA. Thus, the crystallization protrusions CP may be arranged to be suitable to a structure of a thin film transistor by selectively performing the first exemplary embodiment and the second exemplary embodiment according to the structure of the thin film transistor to be formed in the crystallization area CA of the pixel area PX.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| 101, 102: laser irradiation apparatus | |
|---|---|
| 610, 710: first laser mask | |
| 620, 720: second laser mask | |
| 910: laser generator | |
| 911: first laser generator | |
| 912: second laser generator | |
| LB1: first laser beam | LB2: second laser beam |
| CA: crystallization area | NCA: non-crystallization area |
| PX: pixel area | SS: substrate |
| SC: semiconductor layer | SL: scan direction |

What is claimed is:

1. A laser irradiation apparatus that provides a laser beam along a scan direction to a semiconductor layer including a plurality of pixel areas, comprising:
at least one laser mask including a plurality of slit groups respectively facing portions of the plurality of pixel areas; and
a laser generator generating the laser beam that pass through the plurality of slit groups of the at least one laser mask.

2. The laser irradiation apparatus as claimed in claim 1, wherein the plurality of pixel areas of the semiconductor layer are divided into a crystallization area and a non-crystallization area, the crystallization and the non-crystallization area being alternately arranged along the scan direction.

3. The laser irradiation apparatus as claimed in claim 2, wherein the crystallization areas are located in a same position in respective pixel areas.

4. The laser irradiation apparatus as claimed in claim 2, wherein the plurality of slit groups corresponds to the crystallization area of the semiconductor layer.

5. The laser irradiation apparatus as claimed in claim 2, wherein a gap between the plurality of slit groups is the same and is proportional to the scan direction distance of the non-crystallization area of the semiconductor layer.

6. The laser irradiation apparatus as claimed in claim 5, wherein one of the slit groups comprises a plurality of slits having long axes parallel to the scan direction.

7. The laser irradiation apparatus as claimed in claim 6, wherein crystallization protrusions are formed in parallel with the scan direction in the crystallization area of the semiconductor layer.

8. The laser irradiation apparatus as claimed in claim 6, wherein one of the slit groups comprises:
a plurality of first slits in a direction perpendicular to the scan direction; and
a plurality of second slits in a direction perpendicular to the scan direction, the first and second slits being equivalent in size, the plurality of first slits and the plurality of second slits adjacent each other along the scan direction and being shifted from each other by ½ of the slit width.

9. The laser irradiation apparatus as claimed in claim 8, wherein sides of the plurality of first and second slits are gradually narrowed at both ends to an oblique shape.

10. The laser irradiation apparatus as claimed in claim 5, wherein one of the slit groups comprises a plurality of slits having long axes perpendicular to the scan direction.

11. The laser irradiation apparatus as claimed in claim 10, wherein crystallization protrusions are arranged in a direction that crosses the scan direction in the crystallization area of the semiconductor layer.

12. The laser irradiation apparatus as claimed in claim 1, wherein the laser generator comprises:
a first laser generator outputting a first laser beam; and
a second laser generator outputting a second laser beam.

13. The laser irradiation apparatus as claimed in claim 12, wherein the first laser generator and the second laser generator turn on/off output the first and second laser beams with a predetermined cycle.

14. The laser irradiation apparatus as claimed in claim 13, wherein the predetermined cycle is inversely proportional to the scan speed of the first and second laser beams and is directly proportional to the length of the pixel area in the scan direction.

15. The laser irradiation apparatus as claimed in claim 14, wherein one cycle of the predetermined cycle corresponds to a distance of the first and second laser beams irradiated toward the scan direction by the pixel area.

16. The laser irradiation apparatus as claimed in claim 13, wherein a time that at least one of the first and second laser beams is output corresponds to a distance between the crystallization areas along the scan direction in the semiconductor layer, and a time that at least one of the first and second laser beams is turned off corresponds to a distance of the non-crystallization areas along the scan direction in the semiconductor layer.

17. The laser irradiation apparatus as claimed in claim 16, wherein the first laser beam and the second laser beam are sequentially output with a time gap.

18. The laser irradiation apparatus as claimed in claim 12, wherein the first laser beam and the second laser beam have the same scan direction.

19. The laser irradiation apparatus as claimed in claim 12, wherein, when there is more than one laser mask, the first and second laser beams being respectively divided and directed onto each laser mask.
